(19) United States
(12) Patent Application Publication
(10) Pub. No.: US 2018/0210162 A1
(43) Pub. Date: Jul. 26, 2018

(54) IMAGING APPARATUS AND OPERATING METHOD

(71) Applicant: SPECIM, SPECTRAL IMAGING OY LTD, Oulu (FI)

(72) Inventor: Jarkko PUUSAARI, Oulu (FI)

(21) Appl. No.: 15/875,440

(22) Filed: Jan. 19, 2018

(30) Foreign Application Priority Data
Jan. 25, 2017 (EP) 17152984.5

(51) Int. Cl. G02B 7/04; G02B 27/10; H04N 5/225

(52) U.S. Cl. CPC G02B 7/04; H04N 5/2253; G02B 27/10

(57) ABSTRACT

An imaging apparatus comprises a first detector configured to capture a two-dimensional image; a second detector configured to perform single-line imaging and spatially displaced with respect to the first detector; an objective common to the first detector and the second detector being located at the same optical distance from the first detector and the second detector; a directing arrangement configured to direct optical radiation from the common objective to the first detector and the second detector simultaneously or in turns; and a focus device common to the first detector and the second detector being configured to perform a focusing operation for finding a focusing state, where the two-dimensional image captured by the first detector is in focus, and the second detector being configured to capture a single-line image on the basis of the optical radiation directed thereto with said focusing state.

### FIELD

The invention relates to an imaging apparatus and an operating method.

### BACKGROUND

To perform a focusing operation such that an image or a photograph is reliably in focus is challenging when capturing a strip-like image the shape of which is mainly one-dimensional. For example, in strip-photography a 2-dimensional image is formed by capturing a plurality of 1-dimensional images in sequence. Another example relates to hyperspectral imaging where a target may be line-scanned through a slit of a spectrograph in order to provide images one after another. The slit which has a shape of a narrow rectangle provides images which are 1-dimensional in a practical sense. These ways of imaging may be called single-line imaging techniques or push-broom imaging techniques.

There are two main reasons why focusing is challenging when using single-line imaging techniques. One-dimensional image is not easily interpretable because it typically has few recognizable features. Another reason is that particularly hyperspectral cameras use a large aperture in order to collect as much light as possible. The large aperture, in turn, causes the depth of focus to be very narrow and the focus is not easily found when performing the focusing operation.

In the prior art, the problem mainly related to the difficulty to interpret the one-dimensional image has been attempted to cure by attaching a high-contrast object on or in the place of the actual target in order to provide a sharp and easily recognizable change of intensity in the slit-shaped image.

In the prior art, a target may also be line-scanned. When a full image of the target is formed from a plurality of line-scanned images, it can be determined whether the image is in focus or not.

However, both of these methods are slow and often not possible. Hence, there is a need to improve the operation related to focusing of single-line imaging.

### BRIEF DESCRIPTION

The present invention seeks to provide an improvement in the single-line imaging. According to an aspect of the present invention, there is provided an imaging apparatus as specified in claim 1.

According to another aspect of the present invention, there is provided an operating method in claim 15.

The invention has advantages. With the help of a two-dimensional imaging in addition to the single-line imaging it is possible adjust the single-line image in focus in an easy manner.

### LIST OF DRAWINGS

Example embodiments of the present invention are described below, by way of example only, with reference to the accompanying drawings, in which

FIG. 1 illustrates an example of an imaging apparatus;

FIG. 2A illustrates an example of an imaging apparatus which has a two-dimensional detector and a single-line detector which move sideways with respect to an optical axis of optical radiation they receive, and the two-dimensional detector is receiving the optical radiation;

FIG. 2B illustrates an example of the imaging apparatus of FIG. 2A where the two-dimensional detector and the single-line detector are in another position;

FIGS. 3A and 3B illustrate an example of the imaging apparatus which has a mirror for directing the optical radiation to the two-dimensional detector and the single-line detector in turns, and the movement of the two-dimensional detector may be used for scanning;

FIG. 3C illustrates an example of the imaging apparatus the mirror of which is moved for scanning;

FIGS. 4A and 4B illustrate an example of the imaging apparatus which has a prism for directing the optical radiation to the two-dimensional detector and the single-line detector in turns, and the movement of the two-dimensional detector may be used for scanning;

FIG. 4C illustrates an example of the imaging apparatus the prism of which is moved for scanning;

FIG. 5 illustrates an example of the imaging apparatus which has a beam splitter for directing the optical radiation to the two-dimensional detector and the single-line detector simultaneously, and the movement of the two-dimensional detector and/or the movement of the beam splitter may be used for scanning;

FIG. 6 illustrates an example of a spectrograph;

FIG. 7 illustrates an example of the imaging apparatus which has a relay-lens arrangement;

FIG. 8 illustrates an example of a controller; and

FIG. 9 illustrates of an example of a flow chart of an operating method.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

It should be noted that while Figures illustrate various embodiments, they are simplified diagrams that only show some structures and/or functional entities. The connections shown in the Figures may refer to logical or physical connections. It is apparent to a person skilled in the art that the described apparatus may also comprise other functions and structures than those described in Figures and text. It should be appreciated that details of some functions, structures, and the signalling used for the operation and/or controlling are irrelevant to the actual invention. Therefore, they need not be discussed in more detail here.

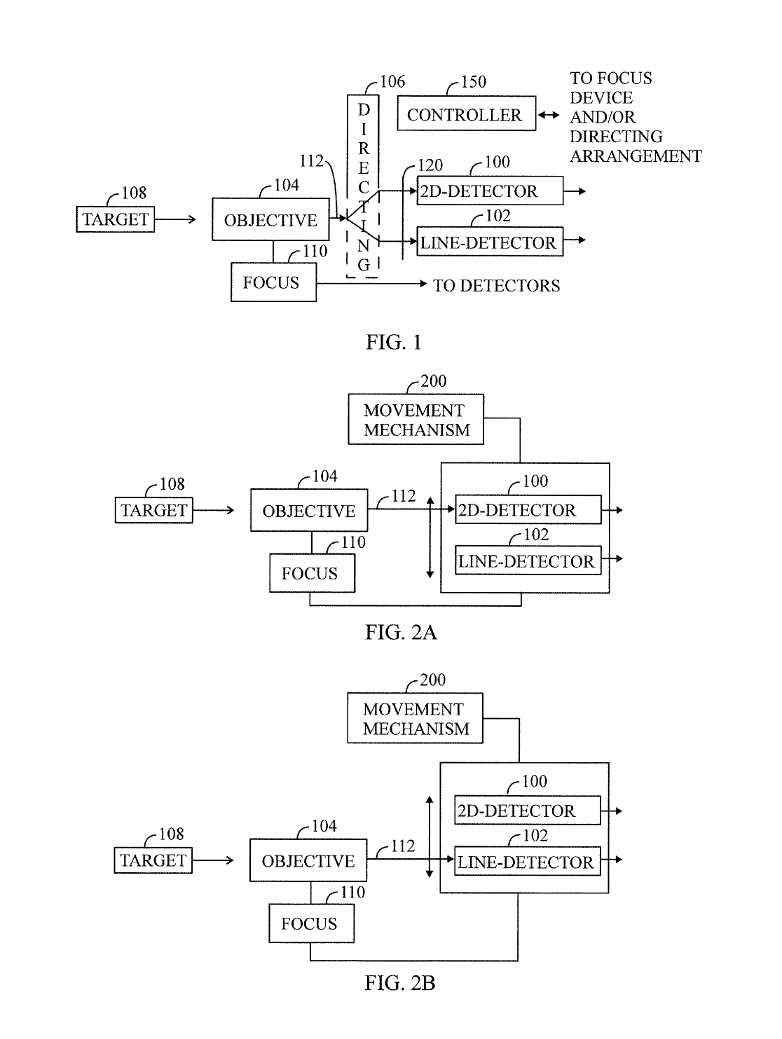

FIG. 1 illustrates an example of an imaging apparatus. The imaging apparatus may be portable. The imaging apparatus may be a hand held electric device which may be like a system camera (a digital single-lens reflex camera) or a pocket camera. The apparatus comprises a first detector 100 which captures a two-dimensional image. The first detector 100 has a pixel matrix sensor which has a plurality of pixel rows and a plurality of pixel column. The pixel matrix sensor may comprise a charge-coupled device element or complementary metal oxide semiconductor element, for example. In an embodiment, the apparatus may be a microscopic device. In an embodiment, the apparatus may be an industrial device which is large and heavy such that it is not a hand-held device or a device portable by one person only.

The apparatus also comprises a second detector 102 which performs single-line imaging performed in line-scanning or push-broom imaging. The single-line imaging refers to imaging where a captured image of a target 108 is like a line. That is, the image has a shape of a narrow rectangle and may be considered as a stripe-image. The image of the shape of the narrow rectangle can be considered to be one dimensional. However, although the image is like a single line, the second detector 102 may have a semiconductor sensor element which is two-dimensional. Only the image is limited to be like a single line. The image carries information of the shape of the target 108. The two-dimensional sensor element may be used to detect spectrum of the target 108 in another dimension. The spectrum is detected from the same area of the target 108 as the single-line image. The second detector 102 may comprise a line-scan camera, for example.

For example, an image of a line-scan camera is a single line. At successive moments, the line-scan camera may capture additional single line images from the target 108 or from a section of the target 108. Then the single line images may be assembled into a two dimensional image or the single line images may be processed as such by a computer. The line-scan camera may be used for inspection of products, for example.

The first detector 100 and the second detector 102 are spatially displaced from each other.

The apparatus also comprises an objective 104 which is common to the first detector 100 and the second detector 102. The objective 104 may comprise one or more lenses. The objective 104 may additionally or alternatively comprise at least one concave or convex mirror and/or other optical component. The objective 104 is located at the same optical distance from the first detector 100 and the second detector 102. In this manner, the objective 104 provides its image plane 120 at an equal distance from the first detector 100 and the second detector 102 when optical radiation 112 from the objective 104 is directed to them.

The apparatus additionally comprises a directing arrangement 106 which directs, simultaneously or in turns, the optical radiation 112 from the common objective 104 to the first detector 100 and the second detector 102. Here, simultaneous means that the directing occurs at the same time. In turns refers to the fact that the directing doesn't occur at the same time but at separate moments.

The apparatus further comprises a focus device 110 which is also common to the first detector 100 and the second detector 102. The focus device 110 may adjust the back focal length of the objective 104 for making the image in the first detector 100 to be in focus. The back focal length may be adjusted, for example, by: changing a refraction index of at least on lens in the objective 104; changing curvature of at least one lens or mirror in the objective 104; or changing mutual positions of at least two lenses, two mirrors and/or a lens and a mirror in the objective 104. Alternatively or additionally, the focus device 110 may adjust the distance between the first detector 100 and the common objective 104 for making the image in the first detector 100 to be in focus.

The focus device 110 performs a focusing operation for finding a focus for the first detector 100. The focusing operation may be performed manually or automatically. Because the image plane 120 is located equally for both the first detector 100 and the second detector 102, the optical radiation from the objective 104 is also in focus for the second detector 102. The second detector 102 the captures a single-line image on the basis of the optical radiation directed thereto. The single-line image of the second detector 102 may also be called an one-dimensional image.

In other words, the focus device 110 performs a focusing operation for finding a focusing state, where the two-dimensional image captured by the first detector 100 is in focus. The second detector 102 then captures a line-image or strip-image using said focusing state with the optical radiation directed thereto by the directing arrangement 106. The focusing state is the state of the apparatus where a position of the image plane 120 and a position of the first detector 100 are adjusted such that an image of the target 108 is in focus in the first detector 100. And when the image is in focus in the first detector 100, the image is also in focus in the second detector 102. The focusing operation requires similar manual or automatic actions as a normal focusing operation of a prior art optical device. That is why the focusing operation and finding the focus don't require knowledge which goes beyond the prior art, per se.

Information about the focusing state, where the two-dimensional image captured by the first detector 100 is in focus, may be received from a common focus device 110 to a controller 150 which then commands the second detector 102 to capture the single-line image, and may additionally command, if necessary, the directing arrangement 106 to direct the optical radiation to the second detector 102 for the image capture. The controller 150 may have a user interface for presenting information and/or images. The interface may also have a touch screen and/or a keyboard for inputting information to be associated with the image data. Additionally or alternatively, the input information may be used to control the image capturing by the apparatus.

In an embodiment an example of which is shown in FIGS. 2A, 2B, 3A, 3B, 3C, 4A, 4B, 4C, 5 and 7, the directing arrangement 106 may comprise a detector movement mechanism 200 which moves at least one of the following: the first detector 100 and the second detector 102 to the optical radiation 112 in turns.

In an embodiment, the movement mechanism 200 may move both the first detector 100 and the second detector 102. The movement mechanism 200 of the directing arrangement 106 may direct the optical radiation 112 to the first detector 100 and the second detector 102 in turns by moving the first detector 100 and the second detector 102 to the optical radiation 112 alternatively.

FIGS. 2A and 2B illustrates an example of an embodiment where the first detector 100 and the second detector 102 can be moved in a perpendicular direction to the optical axis of the incoming optical radiation. In this embodiment, the first detector 100 and the second detector 102 may be physically separated from each other in a direction perpendicular to the optical axis of the optical radiation output by the objective 104 towards the first and second detectors 100, 102.

In FIG. 2A, the first detector 100 is moved to a position where the optical radiation 112 from the common objective 104 hits the first detector 100. Then the image in the first detector 100 is adjusted by the focus device 110 such that the image is in focus.

After focusing, the second detector 102 captures at least one image through a slit for having a single-line image which is in focus on the basis of the focusing operation made by the focusing device 110 for the first detector 100. If a line-scanning is performed, the movement mechanism 200 may move the second detector 102 over the image of the target 108 or over a desired section of the image of the target 108 for forming a two-dimensional image of the target 108 or the desired section of the target 108.

The optical distance between the first detector 100 and the common objective 104 may be the same as the distance between the second detector 100 and the common objective 104 when the first detector 100 and the second detector 102 are located in a position for receiving the optical radiation 112 from the common objective 104.

In an embodiment, the detector movement mechanism 200 may move the second detector 102 in a perpendicular direction to the optical axis of the optical radiation received by the second detector 102, the longitudinal axis of the second detector 102 being perpendicular to both the direction of the movement and the optical axis. The longitudinal axis of the second detector 102 may be a longitudinal axis of a slit 600 (see FIG. 6) in the second detector 102.

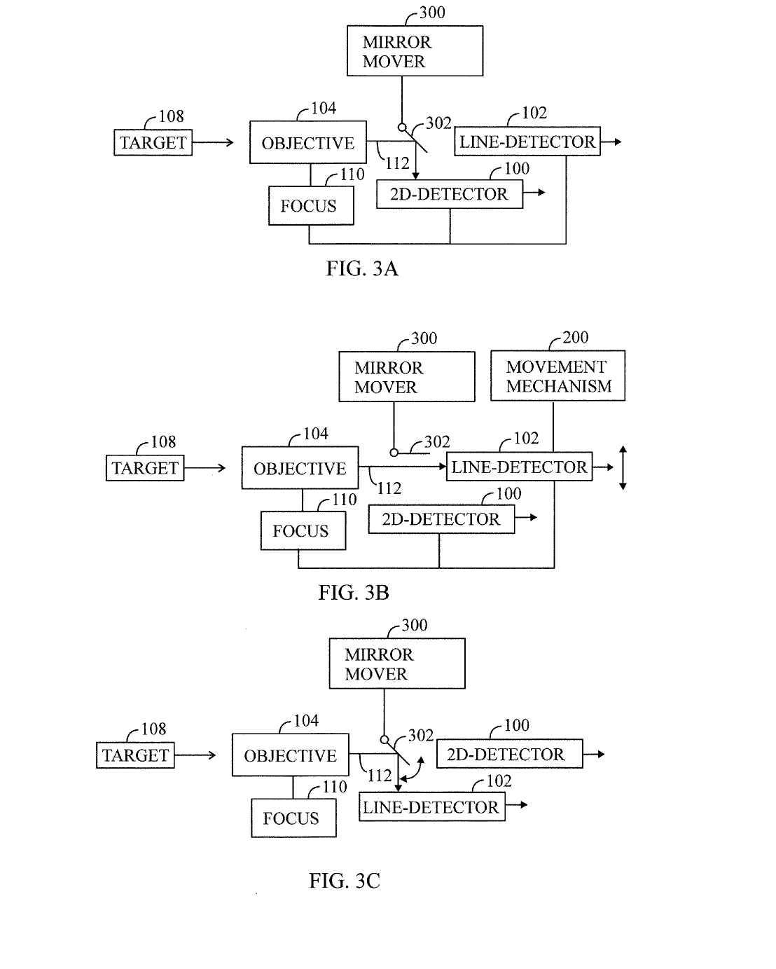

FIGS. 3A and 3B illustrate an example of an embodiment, where the directing arrangement 106 may comprise a reflector 302 and a reflector mover 300. In an embodiment shown in FIGS. 3A and 3B, the reflector 302 comprises a mirror. In FIG. 3A, the mirror mover 300 has rotated the mirror 302 in a position in which the mirror 302 reflects the optical radiation 112 to the first detector 100 for the focusing operation.

In FIG. 3B, the mirror mover 300 has rotated the mirror 302 in a position in which the mirror 302 reflects the optical radiation 112 to the second detector 102. The mirror mover 300 may thus direct the optical radiation to the first direction and the second direction alternatively, the first direction being towards the first detector 100 and the second direction being towards the second detector 102.

In an embodiment, the second detector 102 may be moved back and forth by the detector movement mechanism 200 in order to perform scanning the optical radiation over the second detector 102. In this manner, the second detector 102 may scan over the image of the target 108 or a desired section of the image of the target 108.

In an embodiment an example of which illustrated in FIG. 3C, the mirror mover 300 may rotate the mirror 302 back and forth in order to perform scanning the optical radiation over the second detector 102. Alternatively or additionally, the mirror mover 300 may linearly move the mirror 302 up and down. In this manner, the second detector 102 may scan over the image of the target 108 or a desired section of the image of the target 108. The mirror mover 300 may be an electric motor with or without a gear mechanism or a pneumatic or hydraulic system. The mirror mover 300 may be controlled by the controller 150 to move the mirror 302.

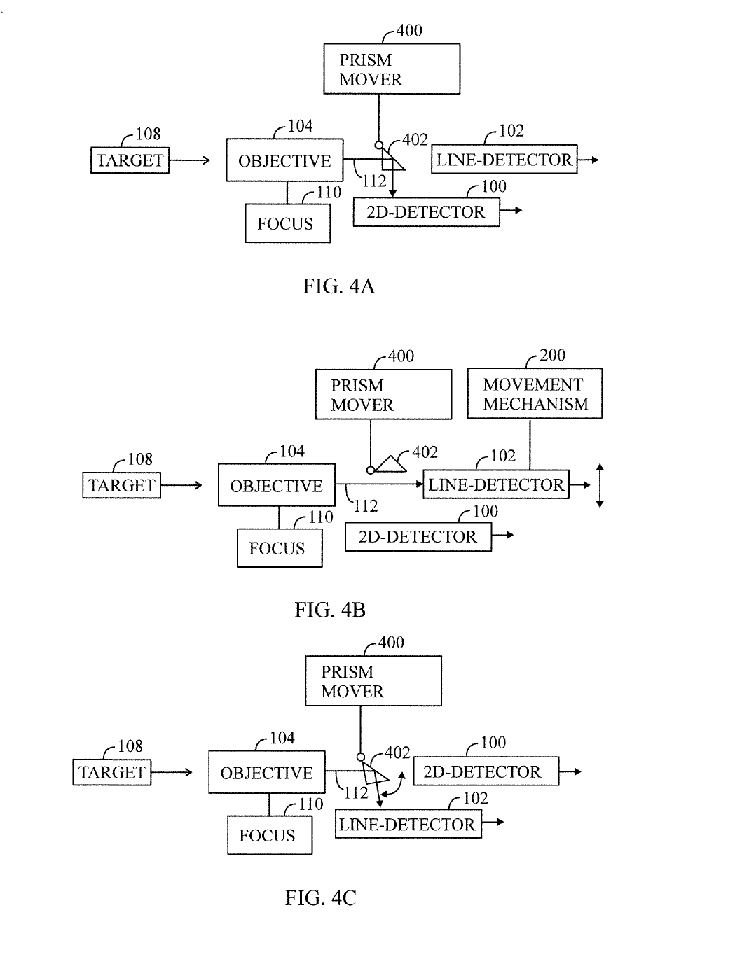

FIGS. 4A and 4B illustrate an example of an embodiment, where the reflector 302 may comprise a prism and the reflector mover 300 may comprise a prism mover 400. In FIG. 4A, the prism mover 400 has rotated the prism 402 in a position in which the prism 402 reflects the optical radiation 112 to the first detector 100 for the focusing operation.

In FIG. 4B, the prism mover 400 has rotated the prism 402 in a position in which the prism 402 reflects the optical radiation 112 to the second detector 102. The prism mover 400 may thus direct the optical radiation to the first direction and the second direction alternatively, the first direction being towards the first detector 100 and the second direction being towards the second detector 102.

In an embodiment, the second detector 102 may be moved back and forth by the detector movement mechanism 200 in order to perform scanning the optical radiation over the second detector 102. In this manner, the second detector 102 may scan over the image of the target 108 or a desired section of the image of the target 108.

In an embodiment an example of which illustrated in FIG. 4C, the prism mover 400 may rotate the prism 402 back and forth in order to perform scanning the optical radiation over the second detector 102. Alternatively or additionally, the prism mover 400 may linearly move the prism 402 up and down. In this manner, the second detector 102 may scan over the image of the target 108 or a desired section of the image of the target 108. The prism mover 400 may be similar to the mirror mover 300. The prism mover 400 may be controlled by the controller 150 to move the prism 402.

Thus in general, the detector movement mechanism 200 may move the second detector 102 for scanning the optical radiation over the second detector 102.

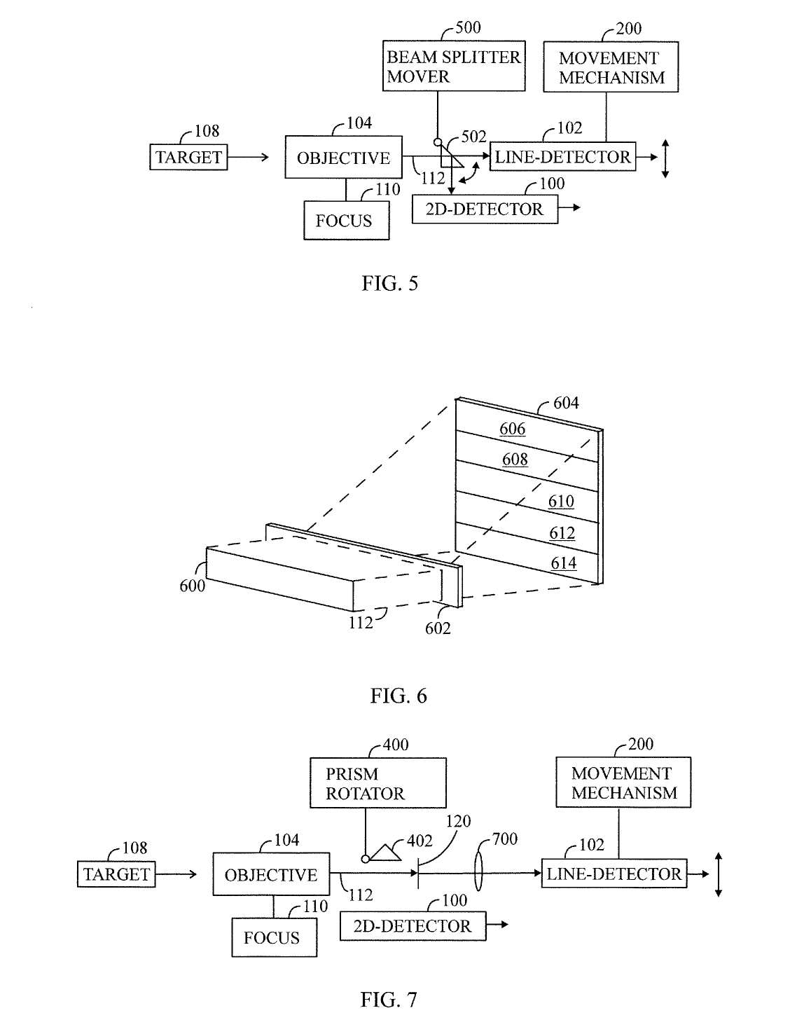

In an embodiment an example of which is illustrated in FIG. 5, the directing arrangement 106 comprises a beam splitter 502. The beam splitter 502 may split the optical radiation 112 to the first direction and to the second direction simultaneously, the first direction being towards the first detector 100 and the second direction being towards the second detector 102. The image in the first detector 100 is adjusted by the focus device 110 such that the image is in focus. After the focusing, the second detector 102 captures at least one image through a slit for having a single-line image which is in focus on the basis of the focusing operation made by the focusing device 110 for the first detector 100. For performing a line-scanning operation, the beam splitter 502 may be linearly moved or rotated by a beam splitter mover 500 and/or the second detector 102 may be moved by the detector mover 200.

Thus, in an embodiment, the directing arrangement 106 may comprise a beam splitter mover 500, which moves the beam splitter 502 for scanning the optical radiation over the second detector 102.

In an embodiment, the beam splitter 502 may be prism-like beam splitter or a partially transparent mirror which at least mostly reflects the part of the optical radiation which doesn't pass through the mirror.

In an embodiment, the first detector 100 may be stationary. The first direction to which the beam splitter 502 splits one beam of the optical radiation 112 may be towards the stationary first detector 100. The second direction to which the beam splitter 502 splits another beam of the optical radiation 112 may be towards a movement range of the second detector 102 moved by the detector movement mechanism 200.

In an embodiment, the common focus device 110 may perform the focusing operation by changing the distance between the common objective 104 and the first and the second detectors 100, 102. In an embodiment, the common focus device 110 may perform the focusing operation by changing a back focal length of the objective 104. In an embodiment, the common focus device 110 may perform the focusing operation by both changing the distance between the common objective 104 and the first and the second detectors 100, 102 and changing a back focal length of the objective 104.

In an embodiment an example of which is illustrated in FIG. 6, the second detector 102 may comprise a spectrograph. The spectrograph has a dispersing component 602 which disperses optical radiation 112 received through the slit 600 into physically separate wavelengths of spectrum on the sensor element 604 of the second detector 102. The spectrum, in turn, is electromagnetic radiation having the wavelength range from about 50 nm to about 1 mm in vacuum on the earth. The spectrum can be detected as separate optical bands 606, 608, 610, 612 and 614. The center wavelength, bandwidth and the number of optical bands 606 to 614 may be selected in a desired manner. The spectrograph may have a prism or a diffraction grating as the dispersing component 602 for dispersing the optical radiation 112.

In an embodiment, the common focus device 110 may form an image plane of the common objective 104 on the slit 600 of the spectrograph in response to the focusing state where the two-dimensional image of the first detector 100 is in focus. In this manner, electromagnetic radiation from a narrow strip of the target 108 is detected by the sensor element 604 using the separate optical bands 606, 608, 610, 612 and 614, the narrow strip being formed by the slit 600. By scanning over the target 108 or a section of the target 108, the scanned strips may be used to form a hyperspectral image of the target 108 or the section of the target 108. Thus, the hyperspectral image has a spatial dimension and a spectral dimension. How to form the hyperspectral image from the separate optical bands 606, 608, 610, 612 and 614, per se, is known by the person in the art.

In an embodiment an example of which is illustrated in FIG. 7, the second detector 102 may comprise at least one relay lens arrangement 700 between the common objective 104 and the second detector 102. In an embodiment, the at least one relay lens arrangement 700 may reside between the common objective 104 and the slit 600 of the second detector 102.

In an embodiment, the first detector 100 may comprise at least one relay lens arrangement between the common objective 104 and the first detector 100 in a manner similar to what is illustrated in FIG. 7 for the second detector 102.

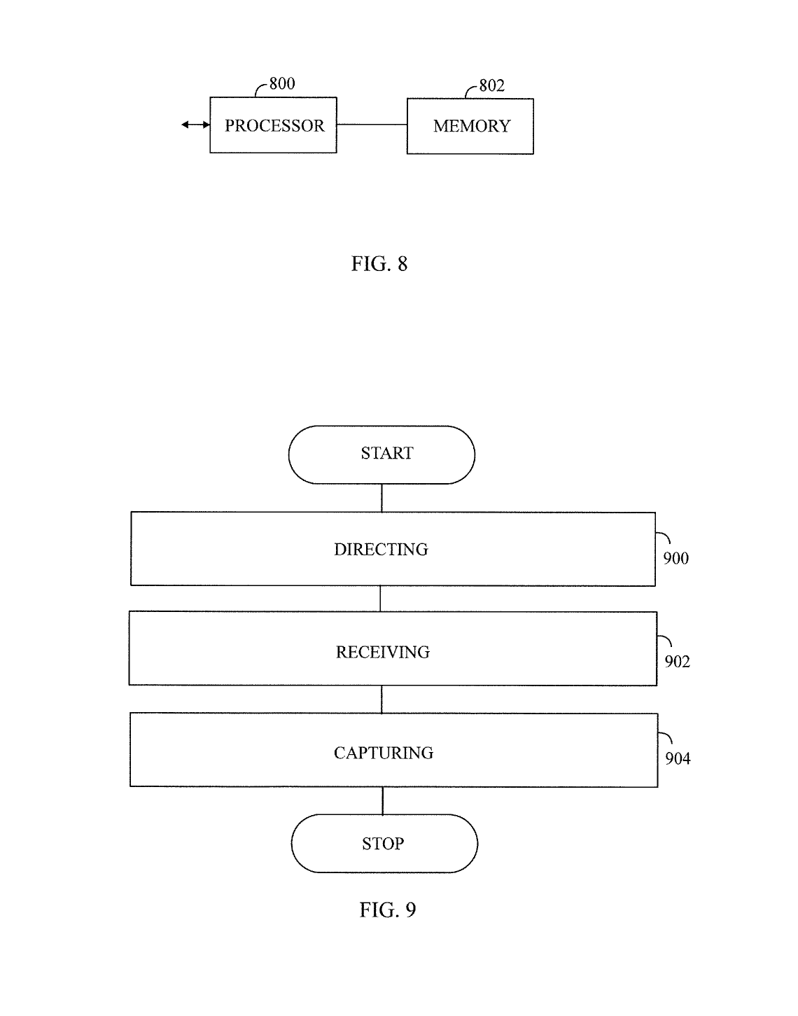

In an embodiment an example of which is shown in FIG. 8, the controller 150 (see FIG. 1) may comprise one or more processors 800 and one or more memories 802 including computer program code. The one or more memories 802 and the computer program code with the one or more processors 800 may cause the controller 150 at least to control the focus device 110 and/or the directing arrangement 106 to perform their actions. The controller 150 may also receive information from the focus device 110 and/or the directing arrangement 106 for performing data processing and outputting its commands for controlling the focus device 110 and/or the directing arrangement 106 to perform their actions.

The first detector 100 sees the same solid angle or target 108 as the second detector 102 because both detectors 100, 102 have the same objective 104 with the same magnification. The first detector 100 may be used to measure the optical power received by the objective 104. The measured optical power may, in turn, be used to estimate the exposure time for the second detector 102. The controller 150 may perform the estimation of the exposure time and also control the actual exposure. On the other hand, the exposure may be performed manually on the basis of the estimated exposure time.

FIG. 9 is a flow chart of the measurement method. In step 900, optical radiation 112 from a common objective 104 to a first detector 100 and a second detector 102 are directed 900 by a directing arrangement 106 simultaneously or in turns, the common objective 104 being common to the first detector 100 and the second detector 102 and being located at the same optical distance from the first detector 100 and the second detector 102, the first detector 100 capturing a two-dimensional image, and the second detector 102 performing single-line imaging and being spatially displaced with respect with the first detector 100. In step 902, information about a focusing state, where the two-dimensional image captured by the first detector 100 is in focus, is received from a common focus device 110 to the first detector 100 and the second detector 102. In step 904, a single-line image is captured by the second detector 102 on the basis of the optical radiation directed thereto using said focusing state.

The method shown in FIG. 9 may be implemented as a logic circuit solution or computer program. The computer program may be placed on a computer program distribution means for the distribution thereof. The computer program distribution means is readable by a data processing device, and it encodes the computer program commands, carries out the measurements and optionally controls the processes on the basis of the measurements.

The computer program may be distributed using a distribution medium which may be any medium readable by the controller. The medium may be a program storage medium, a memory, a software distribution package, or a compressed software package. In some cases, the distribution may be performed using at least one of the following: a near field communication signal, a short distance signal, and a telecommunications signal.

It will be obvious to a person skilled in the art that, as technology advances, the inventive concept can be implemented in various ways. The invention and its embodiments are not limited to the example embodiments described above but may vary within the scope of the claims.

1. An imaging apparatus comprising
a first detector configured to capture a two-dimensional image,
a second detector configured to perform single-line imaging and spatially displaced with respect to the first detector, and
an objective, which is common to the first detector and the second detector, being located at the same optical distance from the first detector and the second detector, wherein the imaging apparatus further comprises
a directing arrangement configured to direct optical radiation from the common objective to the first detector and the second detector simultaneously or in turns, and the directing arrangement comprises at least one of the following for scanning the optical radiation over the second detector directed thereto: a detector movement mechanism configured to move both the first detector and the second detector, both a reflector and a reflector mover configured to rotate or move linearly the reflector that is configured to reflect the optical radiation to the second detector, and both a beam splitter and a beam splitter mover configured to rotate or move linearly the beam splitter that is configured to reflect the optical radiation to the second detector; and
a focus device common to the first detector and the second detector being configured to perform a focusing operation for finding a focusing state, where the two-dimensional image captured by the first detector is in focus, and the second detector being configured to capture a single-line image on the basis of the optical radiation directed thereto with said focusing state.

2. (canceled)

3. (canceled)

4. The imaging apparatus of claim 1, wherein the detector movement mechanism is configured to move the second detector in a perpendicular direction to the optical axis of the optical radiation received by the second detector, the longitudinal axis of an aperture of the second detector being perpendicular to both the direction of the movement and the optical axis.

5. The imaging apparatus of claim 1, wherein the directing arrangement comprises a beam splitter configured to split the optical radiation to the first direction and to the second direction simultaneously, the first direction being for the first detector and the second direction being for the second detector.

6. The imaging apparatus of claim 5, wherein the directing arrangement comprises a beam splitter mover, the beam splitter mover being configured move the beam splitter for scanning the optical radiation over the second detector.

7. The imaging apparatus of claim 1, wherein the directing arrangement comprises a reflector and a reflector mover, the reflector mover being configured to direct the optical radiation to the first direction and the second direction alternatively, the first direction being for the first detector and the second direction being for the second detector.

8. The imaging apparatus of claim 7, wherein the reflector mover being configured to scan the optical radiation over the second detector.

9. The imaging apparatus of claim 5, wherein the first direction being towards the first detector, which is stationary, and the second direction being towards a movement range of the second detector moved by the detector movement mechanism.

10. The imaging apparatus of claim 1, wherein the detector movement mechanism is configured to move both the first detector and the second detector, and to direct the optical radiation to the first detector and the second detector in turns by moving the first detector and the second detector to the optical radiation alternatively.

11. The imaging apparatus of claim 1, wherein the common focus device being configured to perform at least one of the following for performing the focusing operation: change the distance between the common objective and the first and the second detectors, and change a back focal length of the objective.

12. The imaging apparatus of claim 1, wherein the second detector comprises a spectrograph, and the common focus device is configured to form an image plane of the common objective on a slit of the spectrograph in response to the focusing state where the two-dimensional image of the first detector is in focus.

13. The imaging apparatus of claim 12, wherein the second detector comprises at least one relay lens arrangement between the common objective and at least one of the following: the first detector and the second detector.

14. The imaging apparatus of claim 1, wherein
the apparatus comprises a
one or more processors; and
one or more memories including computer program code;
the one or more memories and the computer program code configured to, with the one or more processors, cause apparatus at least to:
direct, by a directing arrangement simultaneously or in turns, optical radiation from the common objective to the first detector and the second detector;
receive, from a common focus device to the first detector and the second detector, information about a focusing state, where the two-dimensional image captured by the first detector is in focus, and
capture, by the second detector, a single-line image on the basis of the optical radiation directed thereto using said focusing state.

15. An operating method of an imaging apparatus, the method comprising
directing, by a directing arrangement simultaneously or in turns, optical radiation from a common objective to a first detector and a second detector, the common objective being common to the first detector and the second detector and being located at the same optical distance from the first detector and the second detector, the first detector capturing a two-dimensional image, and the second detector performing single-line imaging and being spatially displaced with respect with the first detector, and scanning the optical radiation over the second detector directed thereto by at least one of the following: a detector movement mechanism moving both the first detector and the second detector, a reflector mover rotating or moving linearly a reflector that reflects optical radiation to the second detector, and a beam splitter mover rotating or moving linearly a beam splitter that reflects optical radiation to the second detector,
receiving, from a common focus device common to the first detector and the second detector, information about a focusing state, where the two-dimensional image captured by the first detector in focus, and
capturing, by the second detector, a single-line image on the basis of the optical radiation directed thereto using said focusing state.
